(19) United States
(12) Patent Application Publication
(10) Pub. No.: US 2010/0228985 A1
(43) Pub. Date: Sep. 9, 2010

(54) CONTENT MANAGEMENT METHOD AND APPARATUS IN INTELLIGENT ROBOT SERVICE SYSTEM

(75) Inventors: Geonwoo KIM, Daejeon (KR); Seung-Hee OH, Daejeon (KR); Hyung Kyu LEE, Daejeon (KR); Chol Soon JANG, Daejeon (KR); Jong-Wook HAN, Daejeon (KR)

Correspondence Address: AMPACC Law Group, 3500 188th Street S.W., Suite 103, Lynnwood, WA, 98037, US

(73) Assignee: Electronics and Telecommunications Research Institute, Daejeon (KR)

(21) Appl. No.: 12/609,964

(22) Filed: Oct. 30, 2009

(30) Foreign Application Priority Data
Mar. 5, 2009 (KR) 10-2009-0018844

(51) Int. Cl. H04L 9/32; H04L 9/08

(52) U.S. Cl. 713/176; 380/278

(57) ABSTRACT

A content management method in an intelligent robot service system includes: generating a key to distribute the key to a content generation node and a content execution node; generating a signature for a content using the distributed key in the content generation node; providing the content and the signature to the content execution node; and verifying a validity of the content in the content execution node to execute the verified content.

### CROSS-REFERENCE(S) TO RELATED APPLICATION(S)

The present invention claims priority of Korean Patent Application No. 10-2009-0018844, filed on Mar. 5, 2009, which is incorporated herein by reference.

### FIELD OF THE INVENTION

The present invention relates to an intelligent robot service, and, more particularly, a content management method and apparatus suitable for reliably generating contents and safely executing the contents, in an intelligent robot service system.

### BACKGROUND OF THE INVENTION

It became possible that an intelligent robot, so-called an “URC (Ubiquitous Robotic Companion) robot”, provides a user with variable contents and services, thanks to the progress in technologies. For example, the intelligent robot provides a variety of contents and services such as news, weather, education contents, schedule management, home monitoring and cleaning, by communicating with the user, reacting to user's order and reacting to a specific situation.

Further, such an intelligent robot is divided in various types by its purpose, that is, there are intelligent robots for a guide of government and public offices, for homework, for education service and for being a pet. These robots may be equipped with different robot platforms to perform specialized function corresponding to each of the services.

However, the services performed by the intelligent robot may be served without any security procedures when creating and distributing contents. In addition, since a series of procedures of providing the services may be performed using a public network which is easily accessible to anyone, there occurs a security problem. In other words, safety of a content server, which takes charge of creating and distributing contents, cannot be guaranteed. Further, there is a possibility of illegal change of the contents by unauthorized access during transmission of the contents.

Therefore, a content management technology is required, which is capable of acquiring safety and reliability in a process of creating and distributing contents.

### SUMMARY OF THE INVENTION

In view of the above, the present invention provides a content management method and apparatus suitable for reliably generating contents in a content server and safely executing the contents, in an intelligent robot service system.

In accordance with a first aspect of the present invention, there is provided a content management method in an intelligent robot service system, including:

generating a key to distribute the key to a content generation node and a content execution node;

generating a signature for a content using the distributed key in the content generation node;

providing the content and the signature to the content execution node; and

verifying a validity of the content in the content execution node to execute the verified content.

In accordance with a second aspect of the present invention, there is provided a content management apparatus in an intelligent robot service system, including:

a key management server for generating and distributing a key;

a content server for generating a content and generating a signature for the content using the distributed key; and

a robot for receiving the content and the signature and verifying a validity of the content to execute the verified content.

In accordance with a third aspect of the present invention, there is provided a content server for use in an intelligent robot service system including a key management server and a robot, comprising:

a content generator for generating a content;

a key receiver for receiving a key distributed from the key management server;

a signature generator for generating a signature for the content using the distributed key; and

a content provider for combining the content with the signature to provide to the robot.

In accordance with a fourth aspect of the present invention, there is provided a robot for use in an intelligent robot service system including a content server and a key management server, comprising:

a content receiver for receiving a content with a signature generated by the content server;

a key receiver for receiving a key distributed from the key management server;

a signature verifier for verifying a validity of the content; and

a content executor for executing the content according to the verification result from the signature verifier.

### BRIEF DESCRIPTION OF THE DRAWINGS

The above features of the present invention will become apparent from the following description of embodiments given in conjunction with the accompanying drawings, in which:

FIG. 1 illustrates a configuration of a content management apparatus in an intelligent robot service system in accordance with an embodiment of the present invention.

FIG. 2 shows a schematic block diagram of the content server in the content management apparatus shown in FIG. 1.

FIG. 3 shows a schematic block diagram of the intelligent robot in the content management apparatus shown in FIG. 1.

FIG. 4 is a flow diagram illustrating a content management process in an intelligent robot service system in accordance with the embodiment of the present invention.

### DETAILED DESCRIPTION OF THE EMBODIMENTS

Hereinafter, embodiments of the present invention will be described in detail with reference to the accompanying drawings, which form a part hereof.

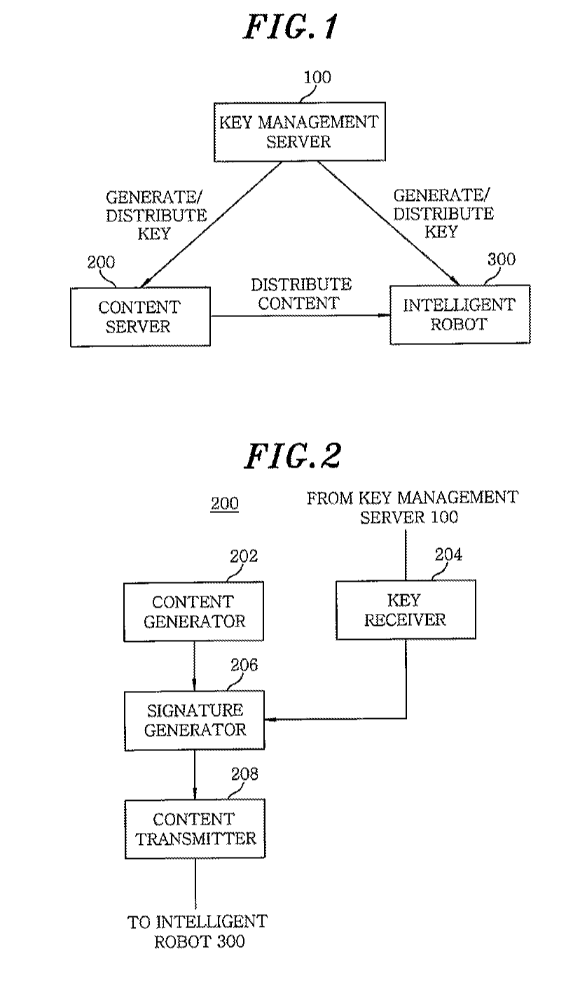

FIG. 1 illustrates a configuration of a content management apparatus in an intelligent robot service system in accordance with an embodiment of the present invention.

The content management apparatus includes a key management server 100, a content server 200, an intelligent robot 300.

As illustrated in FIG. 1, the key management server 100 generates a key to be applied to the embodiment of the present invention and distributes the key to the content server 200 and the intelligent robot 300. In this case, the key may be a public key based on a public key infrastructure (PKI) or a symmetric key. In case of the public key, a procedure of generating and distributing a private key and a certificate and a procedure of verifying the certificate may be included. In case of the symmetric key, a procedure of generating and distributing a symmetric key may be included.

The content server 200, which is one type of content generation nodes, generates an arbitrary content and a signature for the content using the distributed key from the key management server 100. Further, the content server 200 combines the generated content with the signature, and transmits it to the intelligent robot 300.

Here, the signature for the content is generated using a hash function, which uses the key and the content as input factors. Algorithms to be applied to the hash function may be, for example, HMAC_MD5 (Hash Message Authentication Code_MD5), HMAC_SHA-1, RSA (Rivest Shamir Adleman) or others.

The intelligent robot 300, which is one type of content execution nodes, receives the combined content and signature to verify the validity of the content.

Specifically, the intelligent robot 300 separately extracts the content from the combined content and signature, and newly generates a signature for the content using the same method that content server 200 used to generate the signature. Thereafter, the intelligent robot 300 verifies the validity of the content by comparing the newly generated signature to the signature received from the content server 200. If the newly generated signature is equal to the signature received from the content server 200, it is determined that the corresponding content is valid. When the validity of the content is verified, the content may be executed.

FIG. 2 shows a schematic block diagram of the content server 200 in the content management apparatus shown in FIG. 1.

Referring to FIG. 2, the content server 200 includes a content generator 202, a key receiver 204, a signature generator 206, and a content provider 208.

The content generator 202 generates an arbitrary content required by the intelligent robot 300. The key receiver 204 receives the key distributed from the key management server 100 to provide the key to the signature generator 206.

The signature generator 206 generates the signature for the content using the key. Here, the signature is generated using the hash function as described above.

The content provider 208 combines the content with the signature generated by the signature generator 206 and transmits it to the intelligent robot 300. At this time, the content provider 208 performs the transmission using, for example, a wire network or a short-range wireless communication technology such as a Bluetooth, infrared rays, Zig-Bee and the like.

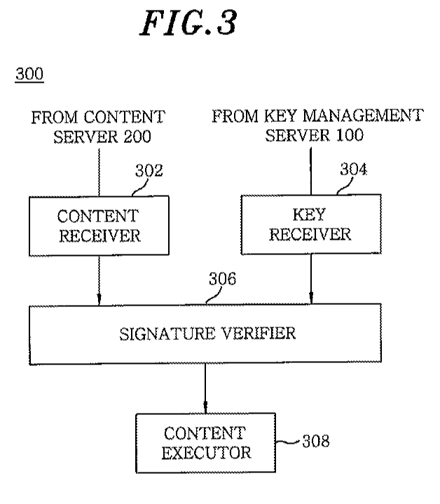

FIG. 3 shows a schematic block diagram of the intelligent robot 300 in the content management apparatus shown in FIG. 1.

As illustrated in FIG. 3, the intelligent robot 300 includes a content receiver 302, a key receiver 304, a signature verifier 306 and a content executor 308.

The content receiver 302 receives the combined content and signature from the content server 200 to provide it to the signature verifier 306. The content receiver 302 receives the content using the wire network or a short-range wireless communication technology, same as the content provider 208.

The key receiver 304 receives the key from the key management server 100 to provide it to the signature verifier 306.

The signature verifier 306 extracts the content from the combined content and signature provided from the content receiver 302 to newly generate a signature for the content using the key from the key receiver 304. Further, the signature verifier 306 compares the new signature to the signature provided from the content receiver 302 to verify the validity of the content.

The content executor 308 executes the content when it is determined by the signature verifier 306 that the content is valid.

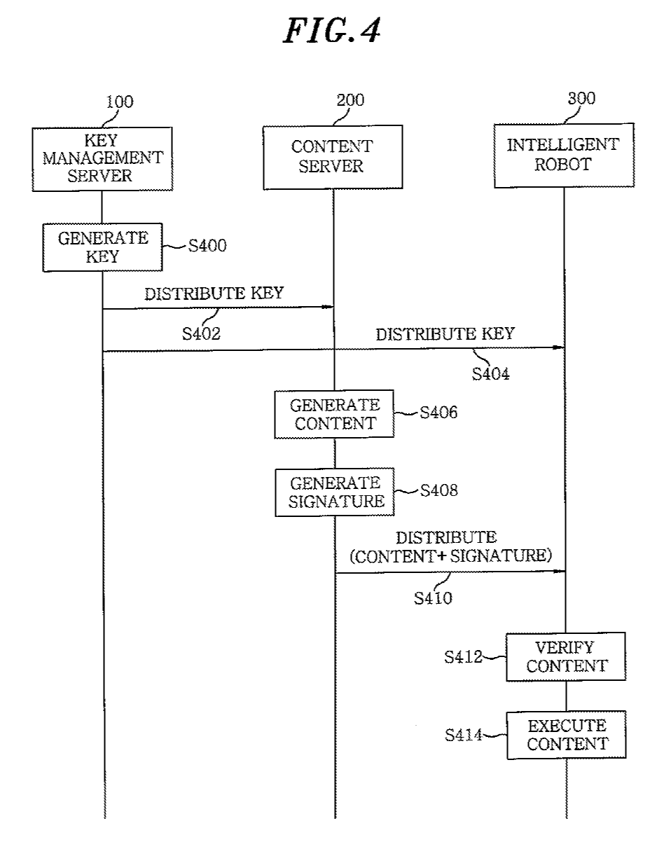

FIG. 4 is a flow diagram illustrating a content management process in an intelligent robot service system in accordance with the embodiment of the present invention.

As illustrated in FIG. 4, the key management server 100 generates a key which is needed for execution of a content at step S400. The generated key is distributed to the content server 200 and the intelligent robot 300 at step S402 and S404, respectively. The content server 200 generates a content to be executed by the intelligent robot 300 at step S406 and generates a signature for the content at step S408. Here, the signature is generated by performing hash function using the distributed key and the generated content as input factors. Thereafter, the content server 200 combines the content with the signature to provide it to the intelligent robot 300 at step S410.

Next, the intelligent robot 300 verifies the validity of the content at step S412. For this verification, first, the content is extracted from the combination of the content and signature. Thereafter, a new signature is generated by performing the same hash function as in step S408 using the key and the extracted content as input factors. Next, the new signature is compared to the received signature from the content receiver 302. If they are equal to each other, it is determined that the received content is valid and, at step S414, the intelligent robot 300 executes the content.

As described above, in accordance with the embodiment of the present invention, a key is distributed to a content server and to an intelligent robot from a key management server, and a content is generated in the content server. Thereafter, a signature for the content is generated using the distributed key, and the signature and the content is provided to the intelligent robot. Then, the intelligent robot extracts the content to generate a new signature for the content. Next, the new signature is compared to the received signature. If they are equal to each other, the content is allowed to be executed. Through such a process, the present invention secures the stability and reliability in content generation and content distribution in an intelligent robot service system. In other words, the stability and reliability of contents provided by an intelligent robot is obtained in intelligent robot service environment based on a public network which is easily accessible to anyone.

While the invention has been shown and described with respect to the embodiments, it will be understood by those skilled in the art that various changes and modification may be made without departing from the scope of the invention as defined in the following claims.

What is claimed is:

1. A content management method in an intelligent robot service system, comprising:
generating a key to distribute the key to a content generation node and a content execution node;
generating a signature for a content using the distributed key in the content generation node;
providing the content and the signature to the content execution node; and
verifying a validity of the content in the content execution node to execute the verified content.

2. The content management method of claim 1, wherein the key includes one of a public key or a symmetric key.

3. The content management method of claim 2, wherein, when the key is the public key, a certificate and private key is generated and distributed so that the certificate is verified by the content execution node.

4. The content management method of claim 2, wherein, when the key is the symmetric key, the symmetric key is generated and distributed.

5. The content management method of claim 1, wherein said providing the content and the signature includes combining the content with the signature to provide the combination to the content execution node.

6. The content management method of claim 1, wherein the signature is generated using a hash function.

7. The content management method of claim 6, wherein said verifying the validity of the content includes newly generating a signature for the content to compare the new signature to the provided signature from the content generation node in order to verify the validity of the content.

8. A content management apparatus in an intelligent robot service system, comprising:
a key management server for generating and distributing a key;
a content server for generating a content and generating a signature for the content using the distributed key; and
a robot for receiving the content and the signature and verifying a validity of the content to execute the verified content.

9. The content management apparatus of claim 8, wherein the key includes one of a public key or a symmetric key.

10. The content management apparatus of claim 9, wherein when the key is the public key, a certificate and a private key is generated and distributed so that the certificate is verified by the robot.

11. The content management apparatus of claim 9, wherein when the key is the symmetric key, the symmetric key is generated and distributed.

12. The content management apparatus of claim 8, wherein the content server combines the content with the signature to provide the combination to the robot.

13. The content management apparatus of claim 8, wherein the signature is generated using a hash function.

14. The content management apparatus of claim 13, wherein the robot newly generates a signature for the content to compare the new signature to the provided signature from the content server in order to verify the validity of the content.

15. A content server for use in an intelligent robot service system including a key management server and a robot, comprising:
a content generator for generating a content;
a key receiver for receiving a key distributed from the key management server;
a signature generator for generating a signature for the content using the distributed key; and
a content provider for combining the content with the signature to provide to the robot.

16. The content server of claim 15, wherein the key includes one of a public key or a symmetric key.

17. The content server of claim 15, wherein the signature is generated using a hash function.

18. A robot for use in an intelligent robot service system including a content server and a key management server, comprising:
a content receiver for receiving a content with a signature generated by the content server;
a key receiver for receiving a key distributed from the key management server;
a signature verifier for verifying a validity of the content; and
a content executor for executing the content according to the verification result from the signature verifier.

19. The robot of the claim 18, wherein the signature verifier newly generates a signature for the content to compare the new signature to the received signature from the content receiver in order to verify the validity of the content.

20. The robot of the claim 19, wherein the new signature is generated using a hash function.
